(19) United States
(12) Patent Application Publication
(10) Pub. No.: US 2008/0046473 A1
(43) Pub. Date: Feb. 21, 2008

(54) Method and System For Using Index Lead Key Self-Join To Take Advantage of Selectivity of Non-Leading Key Columns of an Index

(76) Inventors: Bingjie Miao, Tigard, OR (US); Scott David Lashley, Portland, OR (US); John Frederic Miller, Lake Oswego, OR (US)

Correspondence Address: DILLON & YUDELL, LLP, 8911 N CAPITAL OF TEXAS HWY, SUITE 2110, AUSTIN, TX, 78759, US

(21) Appl. No.: 11/464,771

(22) Filed: Aug. 15, 2006

(51) Int. Cl. G06F 17/30; G06F 12/00

(52) U.S. Cl. 707/200

(57) ABSTRACT

A method of searching for information within a database that includes: identifying a set of leading index key columns, from among a plurality of index key columns, that has a limited number of unique values; utilizing the identified set of leading index key columns to perform an index scan in order to retrieve each unique value from the set of leading index key columns; and utilizing each of the retrieved unique values from the set of leading index key columns to perform an index lead key self-join operation, such that predicates on the non-leading index key columns are utilized to position an index scan operation.

### BACKGROUND OF THE INVENTION

1. Technical Field

The present invention relates in general to the field of computers and other data processing systems, including hardware, software and processes. More particularly, the present invention pertains to searching for information within databases by efficient utilization of an index.

2. Description of the Related Art

A database contains a plurality of records systematically stored within a computer, such that a computer program may access the records in response to queries. A computer program known as a database management system (DBMS) is used to manage and query a database. Within a database, records are typically organized as sets of data items, typically as tables having a plurality of data columns. An index is a data structure within a database that allows a set of rows within a data table that match a specific criterion to be located quickly. The index may be created using one or more columns of the table. Since an index may be smaller in size than the original data table, the index is optimized to increase searching speed. Furthermore, indexes may be classified as unique if the indexes serve as a filter for the data table by preventing the duplication of identical rows within the search results.

A B-Tree index is organized as a tree structure, which facilitates fast searching through the index. Within each internal node of a B-Tree index, (value, pointer) pairs are arranged in order of the value of the index key column(s), and each value has a pointer to a child node where the search should continue. The nodes at the lowest level of the B-Tree index are referred to as “leaf nodes”. In a leaf node each value of index key columns is followed by a list of record identifiers (RIDs) that point to actual records having a corresponding value for the index key columns. Therefore given a value for the index key columns, an index can be searched quickly through the tree structure to identify the set of record identifiers having that value for the index key columns. The process of searching through the index tree structure with a given value to find the corresponding record identifiers is referred to as “index positioning”.

Conventional index search methods involve a starting position and a stopping position on the index. The range between the starting and stopping positions, when compared to the entire range of the index, is often determined by the selectivity of the search keys of the index. An index may have composite index keys, such as an index on columns “c1” and “c2”. In such cases, the efficiency of the index search is largely determined by the selectivity of the leading index key column, “c1”. For example, in a situation where the leading index key column predicates have poor selectivity, but the non-leading index key column predicates offer great selectivity, the database search would still need to scan a large portion of the leading index key column and subsequently throw away keys that do not satisfy the predicates of the non-leading index key column. Current index search methods therefore often require additional memory space and long search times due to the inefficiencies mentioned above. Consequently, the present invention recognizes that there is a need for an improved method and system to increase the efficiency (in terms of both speed and memory space) of database query processing.

### SUMMARY OF THE INVENTION

Disclosed is a method, system, and computer program product for searching for information within a database. In one embodiment, the method includes, but is not limited to, the steps of: identifying a set of leading index key columns, from among a plurality of index key columns, that has a limited number of unique values; utilizing the identified set of leading index key columns to perform an index scan on the set of leading index key columns in order to retrieve each unique value from the set of leading index key columns; and utilizing each of the retrieved unique values from the set of leading index key columns to perform an index lead key self-join operation, such that predicates on the non-leading index key columns are utilized to position an index scan operation.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing system, as utilized in an embodiment of the present invention;

FIG. 2 illustrates a high level description of index lead key self-join in accordance with one embodiment of the invention;

FIG. 3 is a high level logical flowchart of an exemplary method of index lead key self-join in accordance with one embodiment of the invention; and

FIG. 4 illustrates an example of a database search performed using an index lead key self-join operation in accordance with one embodiment of the invention.

### DETAILED DESCRIPTION OF AN ILLUSTRATIVE EMBODIMENT

The present invention provides a method, system, and computer program product for searching for information within a database by utilizing an index lead key self-join operation to increase the efficiency, in both speed and space, of the database search.

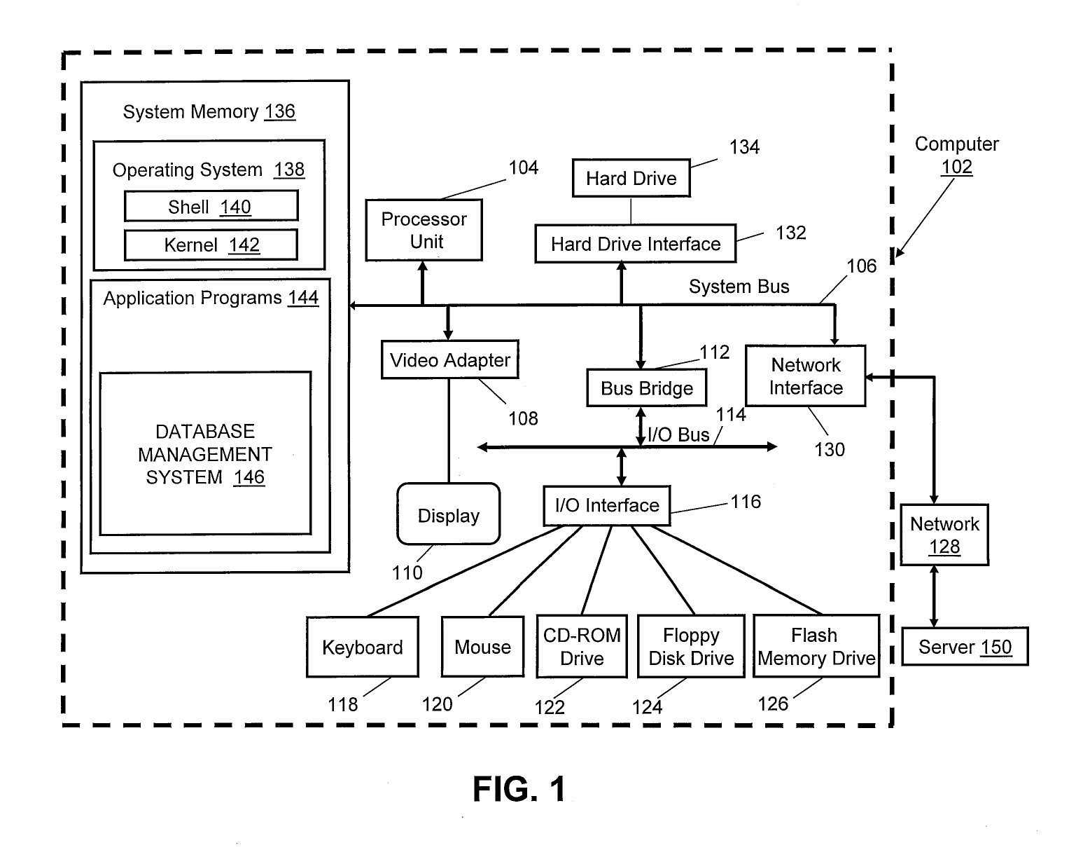

With reference now to FIG. 1, there is depicted a block diagram of an exemplary computer 102, with which the present invention may be utilized. Computer 102 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk—Read Only Memory (CD-ROM) drive 122, floppy disk drive 124, and flash drive memory 126. The format of the ports connected to I/O interface 116 may be any known to those skilled in the art of computer architecture, including but not limited to Universal Serial Bus (USB) ports.

Computer 102 is able to communicate with server 150 via network 128 using network interface 130, which is coupled to system bus 106. Network 128 may be an external network such as the Internet, or an internal network such as an Ethernet or a Virtual Private Network (VPN). Using network 128, computer 102 is able to access server 150.

Hard drive interface 132 is also coupled to system bus 106. Hard drive interface 132 interfaces with hard drive 134. In a preferred embodiment, hard drive 134 populates system memory 136, which is also coupled to system bus 106. System memory is defined as a lowest level of volatile memory in computer 102. This volatile memory may include additional higher levels of volatile memory (not shown), including, but not limited to, cache memory, registers, and buffers. Data that populates system memory 136 includes operating system (OS) 138 and application programs 144.

OS 138 includes shell 140, for providing transparent user access to resources such as application programs 144, and kernel 142, which includes lower levels of functionality for OS 138, including providing essential services required by other parts of OS 138 and application programs 144, including memory management, process and task management, disk management, and mouse and keyboard management.

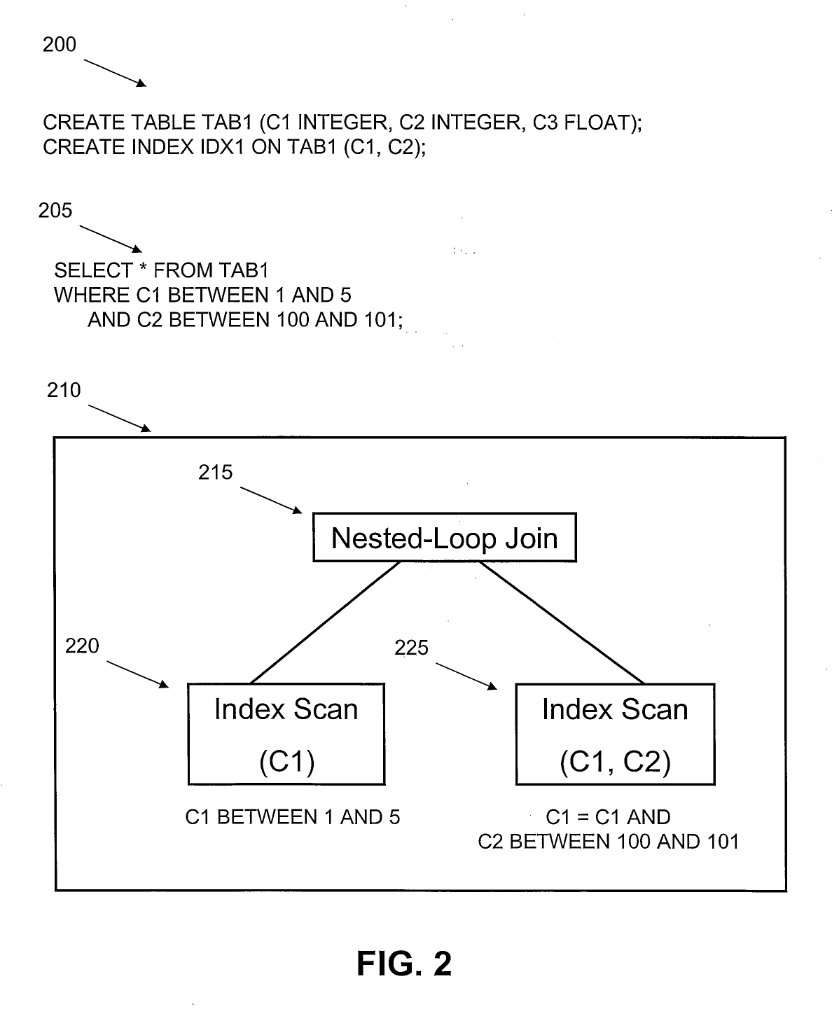

In one embodiment, application programs 144 in system memory 136 include database management system 146. As described further below, database management system 146 may be utilized to implement the process depicted in FIGS. 2-4 wholly or in part.

The hardware elements depicted in computer 102 are not intended to be exhaustive, but rather are representative to highlight certain components that mat be utilized to practice the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

Conventional index search involves a starting position and a stopping position. The starting position and stopping position are identified via index positioning with a start key value and a stop key value, derived from query predicates on the index key columns. An index search starts at the starting position and reads through all items in the index until the stopping position is reached. Therefore the range between the starting position and the stopping position, when compared with the entire range of the index, is an indication of the efficiency of the index search. An index search where only a small portion of the index needs to be accessed is more efficient than an index search where a large portion of the index must be accessed. The efficiency of an index search is determined by the selectivity of the range predicates on the index key column. A composite index has multiple index key columns. In the case of a composite index, the efficiency of an index search is largely determined by the selectivity of the range predicates on the leading key column of the index. For example, with an index defined on columns (c1, c2), and range predicates on both columns “c1” and “c2”, the efficiency of the index search is largely determined by the selectivity of the range predicates on column “c1”. However, in cases where column “c1” has an equality predicate in the form of “c1=constant”, then column “c1” is considered to be “bound” to a constant value, and the efficiency of the index search is then determined by the range predicates on the next index key column, “c2”.

When there are range predicates on both column “c1” and column “c2”, the efficiency of an index search is largely determined by the selectivity of the predicates on column “c1”. If a column contains predicates that have many different unique values, the column is defined as having good selectivity. Columns that contain predicates that have fewer unique values, with respect to other columns, are defined as having poor selectivity. If the predicates on column “c1” have poor selectivity, but the predicates on column “c2” have good selectivity, the efficiency of the index search is poor due to poor selectivity of predicates on column “c1”. Since a user of the index search can only take advantage of the (good) selectivity of column “c2” when column “c1” is bound to a constant value, a method and system are need to convert the predicates on column “c1” into equality predicates.

With reference now to FIG. 2, there is depicted an exemplary schema 200, which includes definition for a table “TAB1” and definition for an index “IDX1” on table “TAB1”. Query 205 includes range predicates on both column “c1” and column “c2” of table “TAB1”. A high level representation of an index lead key self-join 210 is also depicted in accordance with one embodiment of the present invention. Index scan 220 retrieves all unique values of the lead key column “c1” of index “IDX1”. The predicates on column “c1” are used for positioning index scan 220. For each retrieved unique value of lead key column “c1”, nested loop join 215 is performed with inner index scan 225. Index scan 225 uses as predicates “c1=c1 AND c2 between 100 and 101”. Note that the “c1=c1” predicate on column “c1” is a self-join predicate, representing column “c1” being bound to a unique value of “c1” retrieved from outer index scan 220. The self-join predicate is an equality predicate, thereby enabling the range predicates of column “c2” to determine the efficiency of the index search corresponding to index scan 225. Since the range predicates of column “c2” have good selectivity, index scan 225 is efficient. Those skillful in the art will appreciate that the efficiency of an index self-join operation is determined by two main factors: 1) the efficiency of index scan 225; and 2) the number of unique values of lead key column “c1” produced by index scan 220. Accordingly, an index self-join operation is most beneficial when the lead key column(s) of an index has a limited number of unique values, and predicates on non-lead-key column(s) of the index provide good selectivity.

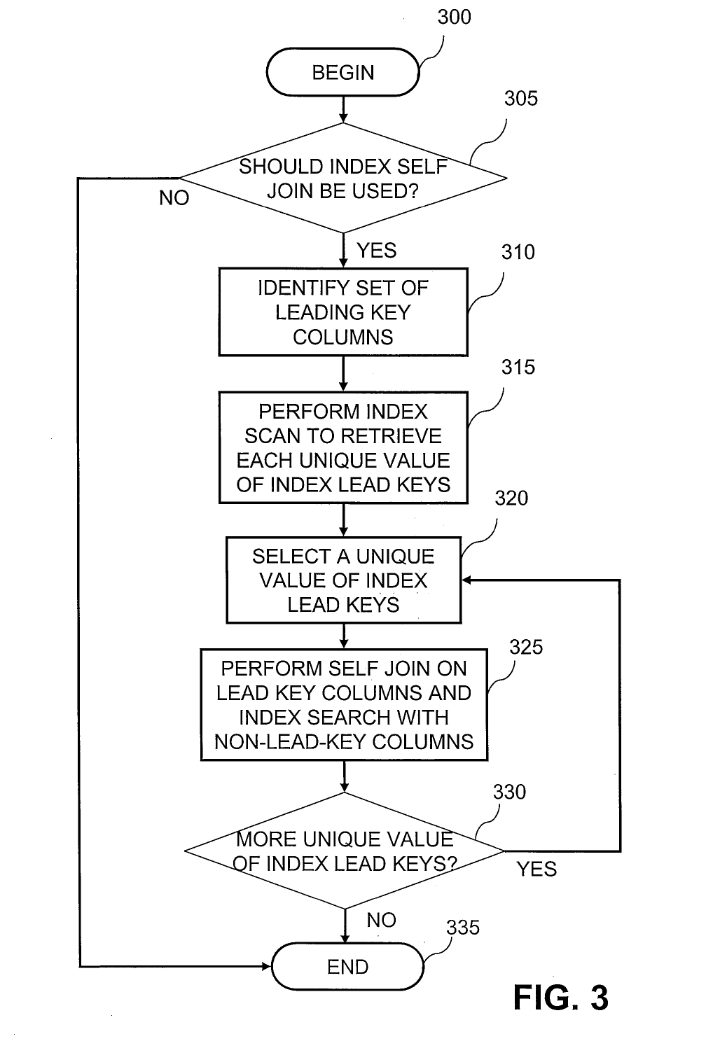

With reference now to FIG. 3, there is depicted a high level logical flowchart of an exemplary method of searching a database by utilizing an index lead key self-join operation in accordance with one embodiment of the invention. The database search process begins at block 300, for example, in response to a user of computer 102 invoking database management system 146, which preferably performs the remainder of the illustrated steps in an automated manner. At block 305, database management system 146 determines whether or not an index self-join operation should be used with one of the available indexes, for efficient access of the underlying table. As described above, index self-join is most efficient when the lead key column(s) of an index has a limited number of unique values, and predicates on non-lead-key column(s) of the index provide good selectivity. A negative response to the test at block 305 will result in termination of the search process at block 335. In the event of a positive response to the test at block 305, the process proceeds to block 310 where a set of leading key columns of the index is designated as index lead key columns. The set of leading index key columns starts out as an empty set. Each index key column is evaluated to determine the potential benefit as well as cost of including this index key column in the set of leading index key columns. If the potential benefit out-weighs the cost, this index key column is added to the set of leading index key columns.

After designation of leading index key columns at block 310, an index scan is used at block 315 to retrieve all unique values for the designated leading index key columns. The set of leading index key columns should have a limited number of unique values, which implies each unique value of the leading index key columns represents a large number of duplicating index items having the same value of leading index key columns. Therefore, to retrieve each unique value of leading index key columns, it is beneficial to reposition the index scan instead of sequentially traversing the index items and discard duplicate items having the same value of leading index key columns. The repositioning of the index scan includes an index positioning operation using the current value of leading index key columns, and requesting the next value beyond the current value.

At block 320, the process enters a loop, in which each unique value of the index lead key columns is used to drive the loop. For each unique value of the index lead key columns, an index search is performed at block 325, utilizing self-join predicates on the index lead key columns and predicates on the non-lead-key columns of the index. After the index search operation at block 325, a determination is made at block 330 to check whether any additional unique values for the index lead key columns exist. A positive response to the determination at block 330 results in a return to block 320, where the next unique value of index lead key columns is selected. A negative response to the determination at block 330 results in the termination of the process at block 335.

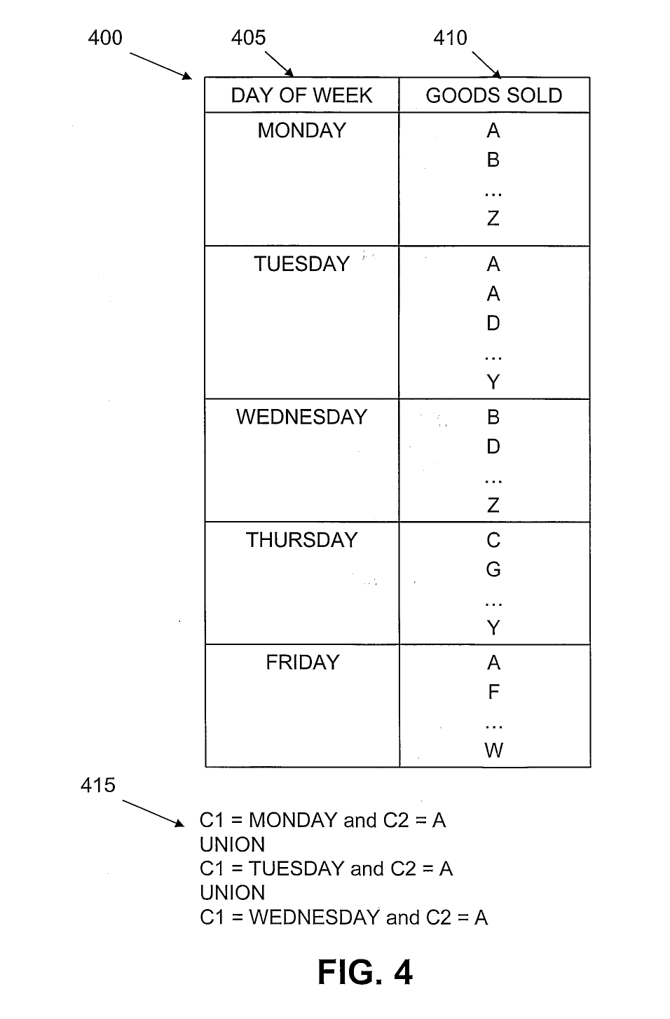

With reference to FIG. 4, there is illustrated an example of a simplified database search performed using an index lead key self-join operation in accordance with one embodiment of the invention. As shown in FIG. 4, database 400 contains an index with two index key columns. Column 1 (C1) 405 contains a list of the days of the week. Column 2 (C2) 410 contains a list of goods (A through Z) that have been sold. Database 400 is arranged such that one or more items in C2 410 may correspond to the day of the week in C1 405 when each item was sold.

In accordance with an embodiment of the invention, a query is entered for sales of item A on Mondays through Wednesdays. Database management system 146 first determines whether index lead key self-join is beneficial for this query. Since column “C1” has only 3 unique values (MONDAY, TUESDAY, and WEDNESDAY) that satisfy the query predicates, and predicates on column “C2” have good selectivity (1/26), index lead key self-join is beneficial for this query. Therefore an index lead key self-join method will be used, with column “C1” as the index lead key column.

The first unique value of column “C1” that satisfies the query predicates is MONDAY (C1=MONDAY), thus an index search with predicates “C1=MONDAY and C2=A” is performed to retrieve the first batch of results, with “C1=MONDAY” as the self-join predicate. Subsequently the next unique value for index lead key column “C1” (TUESDAY) is used in an index search with predicates “C1=TUESDAY and C2=A” to retrieve the next batch of results. The last unique value of column “C1” that satisfies the query predicates is WEDNESDAY, which is used in an index search with predicates “C1=WEDNESDAY and C2=A” to retrieve the last batch of results of the query. Consequently, the index lead key self-join effectively transforms the original query (C1 between MONDAY and WEDNESDAY, and C2=A) into its equivalent form (C1=MONDAY and C2=A UNION C1=TUESDAY and C2=A UNION C1=WEDNESDAY and C2=A) 415. The index lead key self-join method thus avoids accessing regions of the index that do not satisfy the query predicates, and thereby avoids utilizing additional memory and/or time to search through items in the index that do not satisfy the query predicates.

Although the above example includes a single column (column C1) as an index lead key column, in an alternate embodiment multiple index key columns may be utilized as index lead key columns.

It is understood that the use herein of specific names are for example only and not meant to imply any limitations on the invention. The invention may thus be implemented with different nomenclature/terminology utilized to describe the above devices/utility, etc., without limitation.

The present invention thus presents a method, system, and computer-readable medium for searching for information within a database by identifying a set of leading index key columns, which has a limited number of unique values, and utilizing the set of leading index key columns to perform an index lead key self-join operation. The index lead key self-join operation may be performed such that the desired range of the database search may be logically converted into a plurality of smaller ranges within the index combined via a plurality of UNION operations. The index lead key self-join operation thereby avoids accessing the ranges of the index that are not relevant to the query, and only access a plurality of smaller ranges that satisfy the query predicates, thus improving query performance and avoiding excess memory/time requirements.

Note that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A method of searching for information within a database, the method comprising:
identifying a set of leading index key columns, from among a plurality of index key columns, that has a limited number of unique values;
utilizing the identified set of leading index key columns to perform an index scan on the set of leading index key columns to retrieve each unique value of the set of leading index key columns; and
utilizing each retrieved unique value of the set of leading index key columns to perform an index lead key self-join operation, such that predicates on the non-leading index key columns are utilized to position an index scan operation.

2. The method of claim 1, wherein the step of identifying the set of leading index key columns includes a cost/benefit evaluation for inclusion of each index key column in the set of leading index key columns.

3. The method of claim 1, wherein the step of utilizing the identified set of leading index key columns to perform the index scan on the set of leading index key columns includes repositioning the index scan for retrieving each unique value of the set of leading index key columns.

4. The method of claim 3, wherein the step of repositioning the index scan further comprises using a current value of leading index key columns to request a next unique value of leading index key columns.

5. The method of claim 1, wherein the index lead key self-join operation comprises creating a plurality of self-join predicates, one for each index key column in the set of leading index key columns, and using the created self-join predicates as well as predicates on non-leading-key columns of the index to perform an index scan operation.

6. The method of claim 5, wherein the use of the self-join predicates and predicates on non-leading key columns of the index further comprises precise positioning of the range of the index scan.

7. A computer-readable medium embodying computer program code for controlling an index lead key self-join operation within a database, the computer program code comprising computer executable instructions configured for:
identifying a set of leading index key columns, from among a plurality of index key columns, that has a limited number of unique values;
utilizing the identified set of leading index key columns to perform an index scan on the set of leading index key columns to retrieve each unique value of the set of leading index key columns; and
utilizing each retrieved unique value of the set of leading index key columns to perform an index lead key self-join operation, such that predicates on the non-leading index key columns are utilized to position an index scan operation.

8. The computer-readable medium of claim 7, wherein the step of identifying the set of leading index key columns includes a cost/benefit evaluation for inclusion of each index key column in the set of leading index key columns.

9. The computer-readable medium of claim 7, wherein the step of utilizing the identified set of leading index key columns to perform the index scan on the set of leading index key columns includes repositioning the index scan for retrieving each unique value of the set of leading index key columns.

10. The computer-readable medium of claim 9, wherein the step of repositioning the index scan further comprises using a current value of leading index key columns to request a next unique value of leading index key columns.

11. The computer-readable medium of claim 7, wherein the index lead key self-join operation comprises creating a plurality of self-join predicates, one for each index key column in the set of leading index key columns, and using the created self-join predicates as well as predicates on non-leading-key columns of the index to perform an index scan operation.

12. The computer-readable medium of claim 11, wherein the use of the self-join predicates and predicates on non-leading key columns of the index further comprises precise positioning of the range of the index scan.

13. A data processing system comprising:
a processing unit;
data storage coupled to the processing unit; and
program code embodied within the data storage, the program code comprising code for an index lead key self-join operation that causes a data processing system to perform a method of searching a database, including the following steps:
identifying a set of leading index key columns, from among a plurality of index key columns, that has a limited number of unique values;
utilizing the identified set of leading index key columns to perform an index scan on the set of leading index key columns to retrieve each unique value of the set of leading index key columns; and
utilizing each retrieved unique value of the set of leading index key columns to perform an index lead key self-join operation, such that predicates on the non-leading index key columns are utilized to position an index scan operation.

14. The data processing system of claim 13, wherein the step of identifying the set of leading index key columns includes a cost/benefit evaluation for inclusion of each index key column in the set of leading index key columns.

15. The data processing system of claim 13, wherein the step of utilizing the identified set of leading index key columns to perform the index scan on the set of leading index key columns includes repositioning the index scan for retrieving each unique value of the set of leading index key columns.

16. The data processing system of claim 15, wherein the step of repositioning the index scan further comprises using a current value of leading index key columns to request a next unique value of leading index key columns.

17. The data processing system of claim 13, wherein the index lead key self-join operation comprises creating a plurality of self-join predicates, one for each index key column in the set of leading index key columns, and using the created self-join predicates as well as predicates on non-leading-key columns of the index to perform an index scan operation.

18. The data processing system of claim 17, wherein the use of the self-join predicates and predicates on non-leading key columns of the index further comprises precise positioning of the range of the index scan.
